(19) United States
(12) Patent Application Publication
(10) Pub. No.: US 2003/0229693 A1
(43) Pub. Date: Dec. 11, 2003

(54) Self-correcting monitor

(75) Inventors: Robert A. Mahlik, Rochester, MN (US); Susette M. Townsend, Rochester, MN (US)

Correspondence Address: Grant A. Johnson, IBM Corporation, Dept. 917, 3605 Highway 52 North, Rochester, MN, 55901-7829, US

(73) Assignee: International Business Machines Corporation, Armonk, NY

(21) Appl. No.: 10/163,650

(22) Filed: Jun. 6, 2002

(51) Int. Cl. G06F 15/173

(52) U.S. Cl. 709/224

(57) ABSTRACT

The present invention provides methods and systems for monitoring one or more performance metrics of a computer system over a monitor interval. In general, a computer system is configured with a monitor program. The monitor program increases a length of the monitor interval in response to determining the monitor program has fallen behind in processing data for the one or more performance metrics.

### BACKGROUND OF THE INVENTION

1. Field of the Invention

The present invention relates generally to methods and systems for monitoring networked computer systems, and in particular, for dynamically adjusting a monitor interval length of a monitor program.

2. Description of the Related Art

Monitor programs are commonly used to monitor performance of a computer system or a network of computer systems. Monitor programs may monitor performance at a variety of levels, including the network level, the system level, the resource level and the application level. Monitor programs typically gather data for a predetermined performance parameter (commonly referred to as a “metric”), over a pre-selected monitor interval. Examples of metrics that may be monitored include, but are not limited to, central processing unit (CPU) usage, available disk storage, disk I/O processor utilization, communication line utilization, and job log messages.

Commonly, monitor programs are part of a network management software package that allows a user, such as a system administrator, to manage multiple computer systems interconnected across a network. The network management software allows the user to define groups of computer systems (commonly referred to as “system groups”) and their associated resources, perform remote and long running operations, and distribute management and user data or files across a system group. Accordingly, the monitor program provided with the network management software allows the user to monitor resources of multiple computer systems and/or multiple system groups. Typically, the user views graphical representations of the data gathered by the monitor program on a graphical user interface (GUI).

The user also uses the GUI to create a monitor definition, specifying, for example, a system or group of systems to monitor and a number of resources to monitor (jobs, queues, etc.). The monitor definition also includes the selected metrics to be monitored, and the monitor intervals over which data is gathered for the selected metrics. The monitor interval is the period of time over which data for the selected metrics is gathered. For example, a user may define a job monitor to monitor, over a specified monitor interval of fifteen seconds, messages logged by all jobs (commonly referred to as “job log messages”) running on a selected system. Every fifteen seconds, the job monitor running on the selected computer system gathers the job log messages and sends them to a central system, where they may be stored in a database and/or forwarded to the GUI for display.

Each metric may require a different amount of data processing at each monitor interval to determine current readings and whether or not the monitor should “trigger” an event based on the current readings. However, a problem occurs if the monitor program falls behind in processing an interval's data for a given metric (referred to herein as a “fall-behind condition”). The monitor program falls behind when the amount of time required to process data for an interval affects the processing of subsequent intervals.

The problem may be described with reference to the job monitor described above. If the job monitor is defined to monitor all the jobs on the selected system, and the system is heavily used, there may be thousands of jobs, each generating job log messages. Therefore, the job monitor may be required to gather thousands of job log messages each monitor interval. Because reading each job log message may require a relatively slow application program interface (API) call, the time required to gather all the job log messages may exceed the monitor interval causing the job monitor to fall behind.

Current monitor programs fail (i.e., terminate prematurely) when they fall behind, which limits their utility. For example, a user may intend to monitor a number of metrics overnight only to return the next morning to find the monitor failed due to a fall-behind condition, which may result in loss of a night's worth of data. Numerous factors affect the time required to gather data for a monitored metric, such as age of the computer system, amount of data associated with each metric, and the number of jobs running on a monitored system. These factors may not be readily available to a user defining a monitor. As a result, users may not have adequate information to select a proper interval time. Further, these factors may be continuously changing. As an example, a CPU-intensive application may load down a system momentarily, and increase an amount of time required to process data for a metric. Although the increase may be momentary, it may result in a fall-behind condition, monitor failure and an associated loss of data.

Accordingly, there is a need for an improved system and method for monitoring performance metrics.

### SUMMARY OF THE INVENTION

The present invention generally provides systems, methods and articles of manufacture for dynamically adjusting the length of a monitor interval for a monitor program.

One embodiment provides a method of dynamically adjusting a length of the monitor interval for a monitor program. The method comprises monitoring, with the monitor program, one or more performance metrics of a computer system, determining whether the monitor program has fallen behind in processing data for a monitor interval, and if so, increasing the length of the monitor interval. The monitored computer system may be part of a network of computer systems.

Another embodiment provides a computer readable medium containing a program which, when executed by a processor, performs an operation for dynamically adjusting the length of a monitor interval for the program. The operation comprises determining whether the program has fallen behind in processing data for a monitor interval, and if so, increasing the length of the monitor interval.

Still another embodiment provides a network comprising a central computer system, a graphical client and one or more endpoint computer systems. The graphical client comprises a graphical user interface (GUI) for creating a definition for a monitor program specifying performance metrics to monitor for the one or more endpoint systems and a monitor interval for the performance metrics. The monitor definition is stored in a database on the central computer system. The monitor program runs on the one or more endpoint computer systems according to the monitor definition. The monitor program is configured to dynamically adjust the length of the monitor interval in response to determining the monitor program has fallen behind in processing data for a monitor interval.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary computer system.

FIG. 2 illustrates an exemplary network environment.

FIG. 3 is a flow diagram illustrating exemplary operations of a method according to one embodiment of the present invention.

FIG. 4 is a flow diagram illustrating exemplary operations of a method according to another embodiment of the present invention.

FIG. 5 illustrates an exemplary graphical user interface (GUI) screen for defining a monitor application.

FIG. 6 is a flow diagram illustrating exemplary operations of a method according to yet another embodiment of the present invention.

### DETAILED DESCRIPTION OF THE PREFERRED EMBODIMENTS

The present invention provides methods and systems for monitoring a computer system or network of computer systems. In general, a monitor program is configured by a user, such as a system administrator, to monitor (i.e., gather data for) one or more performance metrics over a user-specified monitor interval. The monitor program dynamically adjusts the monitor interval in response to determining the monitor program has fallen behind in processing data for the one or more performance metrics.

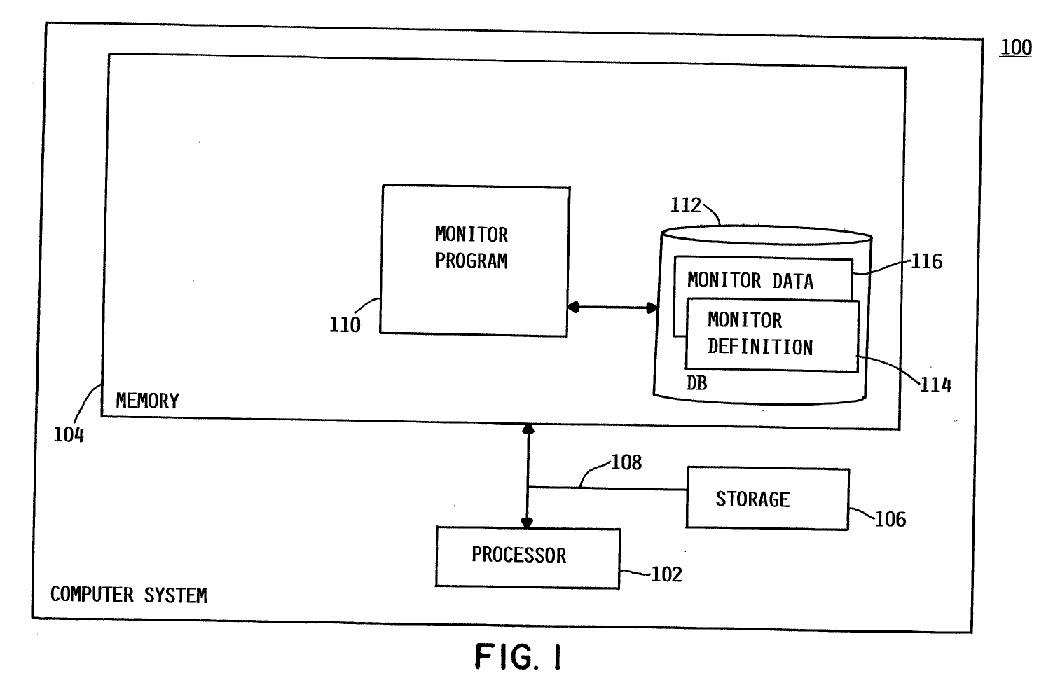

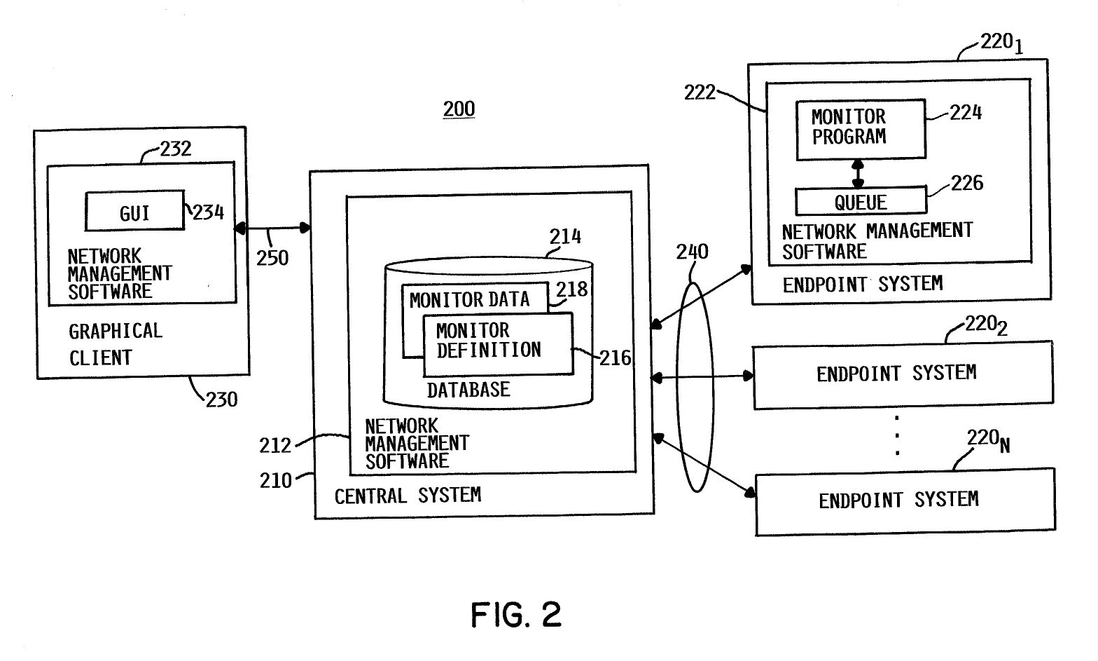

Embodiments of the invention are implemented as program products for use with, for example, the exemplary computer system 100 illustrated in FIG. 1 or the exemplary network environment 200 illustrated in FIG. 2, both described below. The program(s) of the program product defines functions of the embodiments (including the methods described below) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

As illustrated in FIG. 1, the computer system 100 generally comprises a processor 102, a memory 104 and a storage device 106 connected by a bus 108. Illustratively, the processor is a PowerPC available from International Business Machines of Armonk, New York (IBM). More generally, however, any processor configured to implement the methods of the present invention may be used to advantage. Further, the computer system 100 may comprise more than one processor 102.

The storage device 106 is preferably a direct access storage device (DASD) and, although it is shown as a single unit, it could be a combination of fixed and/or removable storage devices, such as fixed disc drives, floppy disc drives, tape drives, removable memory cards, or optical storage. The memory 104 could also be one or a combination of memory devices, including Random Access Memory, nonvolatile or backup memory, (e.g., programmable or Flash memories, read-only memories, etc.) and the like. In addition, memory 104 may be considered to include memory physically located external to the computer system 100, for example, any storage capacity used as virtual memory or stored on a mass storage device or on another computer coupled to the computer system 100 via the bus 108. Further, the memory 104 and the storage device 106 could be part of one virtual address space spanning multiple primary and secondary storage devices.

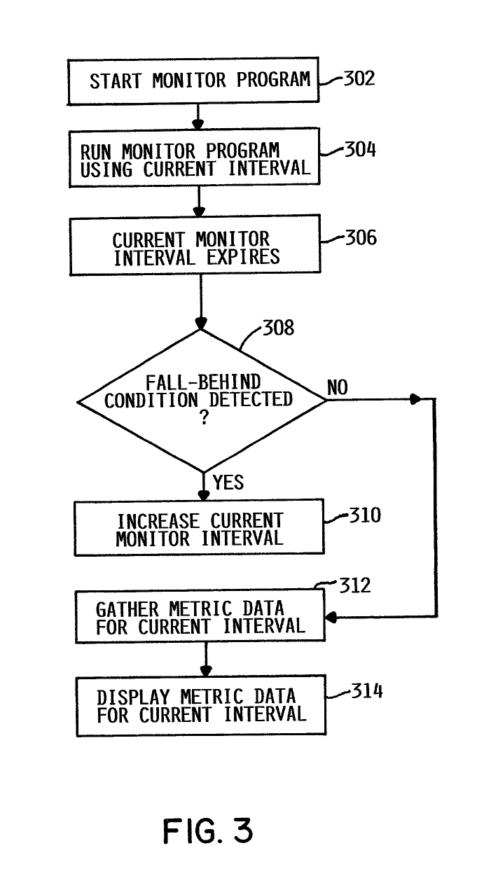

As illustrated, the memory 104 includes a monitor program 110 and a database 112, which may be used to store a monitor definition 114 and monitor data 1 16 gathered by the monitor program 110. Operations of the monitor program 110 may be described with reference to FIG. 3, which is a flow diagram illustrating exemplary operations of a method 300 according to one embodiment of the present invention.

The method 300 is initiated at step 302 when a user starts the monitor program 110. For example, the monitor program 110 may be loaded into memory 104 from storage 106. Upon loading, the monitor program 110 may access the monitor definition 114 stored in the database 112, which defines one or more metrics to monitor and a user-defined monitor interval for each metric. At step 304, the monitor program 110 runs using the user-defined monitor interval as the current monitor interval.

At step 306, the current monitor interval expires and, at step 308, the monitor program 110 determines if a fall-behind condition has occurred. The monitor program may use any suitable technique to determine if a fall-behind condition has occurred. For example, the monitor program 110 may determine a fall-behind condition exists if a response to a request for data from a previous interval has not been received. Alternatively, the monitor program 110 may not determine a fall-behind condition has occurred until requests for data from a number of consecutive intervals have gone unanswered.

As previously described, conventional monitor programs fail upon detecting a fall-behind condition. However, as illustrated in step 310, rather than fail, monitor program 110 of the present invention dynamically increases the current monitor interval in response to detecting a fall-behind condition. By dynamically increasing the current monitor interval, the monitor program 110 may recover from the fall-behind condition and avoid future fall behind conditions. Hence, the monitor program 110 is a self-correcting monitor program that may be more robust than current monitor programs.

The monitor program 110 may increase the current monitor interval length to a new value according to different algorithms for different embodiments. For some embodiments, the monitor program may increase the current monitor interval to a next highest value from a list of valid monitor intervals. For example, when creating a monitor definition, a user may choose from a list of monitor intervals (such as 15 seconds, 30 seconds, 5 minutes, etc.). In such an embodiment, the monitor program 110 may increase the current monitor interval from 15 seconds, for example, to 30 seconds in response to detecting a fall-behind condition. For other embodiments, the current monitor interval length may be increased to values other than a list of valid monitor intervals, according to any suitable algorithm. For example, the monitor program 110 may be configured to increment the monitor interval by a predefined value (i.e., 2 seconds). The monitor program may repeatedly increment the monitor interval by the predefined value until an acceptable monitor interval is reached. In another embodiment, the monitor program 110 may rely on historical adjustments to the monitor interval to determine an acceptable value. In any case, the new monitor interval length may be stored in the database 112 and/or the monitor definition 114 may be updated to reflect the new monitor interval length.

After the current monitor interval is increased at step 310, steps 302-308 may be repeated, and the monitor interval may be increased again, as necessary. Once the monitor interval is changed, the amount, values and/or type of data collected over the new monitor interval may change. Accordingly, the monitor program 110 may be configured to notify a user and/or update a GUI to reflect changes to the monitor interval. However, the particular techniques used to notify the user and/or update the GUI are design choices left to the discretion of those skilled in the art. As illustrated, if a fall-behind condition is not detected, the monitor program 110 processes metric data for the current monitor interval at step 312, and displays the processed data at step 314.

For some embodiments, the monitor program 110 may adjust the monitor interval back down in response to determining that a predefined amount of time has elapsed without detecting a fall-behind condition. The monitor program 110 may dynamically decrease the monitor interval time according to similar algorithms used to dynamically increase the monitor interval length, for example, using the original user-specified monitor interval length as a minimum value.

As previously described, a monitor program may be part of a network management software package that allows a user, such as a system administrator, to manage multiple computer systems interconnected across a network, such as the exemplary network illustrated in FIG. 2. The network 200 generally comprises a central system 210, with one or more endpoint systems 220 (220₁, 220₂ . . . 220ₙ) and a graphical client 230 connected to the central system 210. A monitor program 224 gathers data 218 for one or more metrics of the one or more endpoint systems 220 and sends the data 218 back to the central system 210 where it may be stored in a database 214 and/or forwarded to the graphical client 230 for display on a GUI 234.

As illustrated, instances of the network management software 212, 222, and 232 may be running on the central system 210, the endpoint systems 220, and the graphical client 230, respectively. The network management software may be any software that provides centralized network management facilities, such as Management Central available from IBM.

As used herein, an endpoint system refers to any computer system on a network that a user wishes to manage, while a central system refers to any computer system selected by a user to store network management data and connect to endpoint systems. In other words, the terms endpoint system and central system refer to roles a computer system may assume. Accordingly, a single computer system may be both a central system for a group of endpoint systems as well as an endpoint system connected to another central system. Further, although not shown, the central system 210, each of the endpoint systems 220 and the graphical client 230 may each be equipped with well-known hardware, such as a memory, processor, storage, input/output devices, etc., as previously described. Accordingly, the network management software may be understood as contents residing in memory.

The central system 210 and the endpoint systems 220 communicate (i.e., transmit data) via network connections 240, while the graphical client 230 communicates with the central system 210 via network connection 250. The network connections 240 and 250 may be any suitable type network connections, such as TCP/IP connections. In this regard, it is contemplated that the network management software running on the central system 210, endpoint systems 220, and the graphical client 230 may be configured with messaging facilities. One messaging facility that can be used to advantage is IBM's MQ Series. The particular methods for data transmission are not limiting of the present invention and persons skilled in the art will recognize a number of suitable mechanisms, whether known or unknown.

Further, the network connections 240 and 250 may be wired or wireless connections. For some embodiments, the graphical client to be a wireless device, such as a personal digital assistant (PDA) or a cellular telephone. This may be particularly advantageous in that a system administrator may be able to monitor network resources from remote locations. For example, a system administrator may be able to monitor, from home, a software installation scheduled to be performed over a weekend.

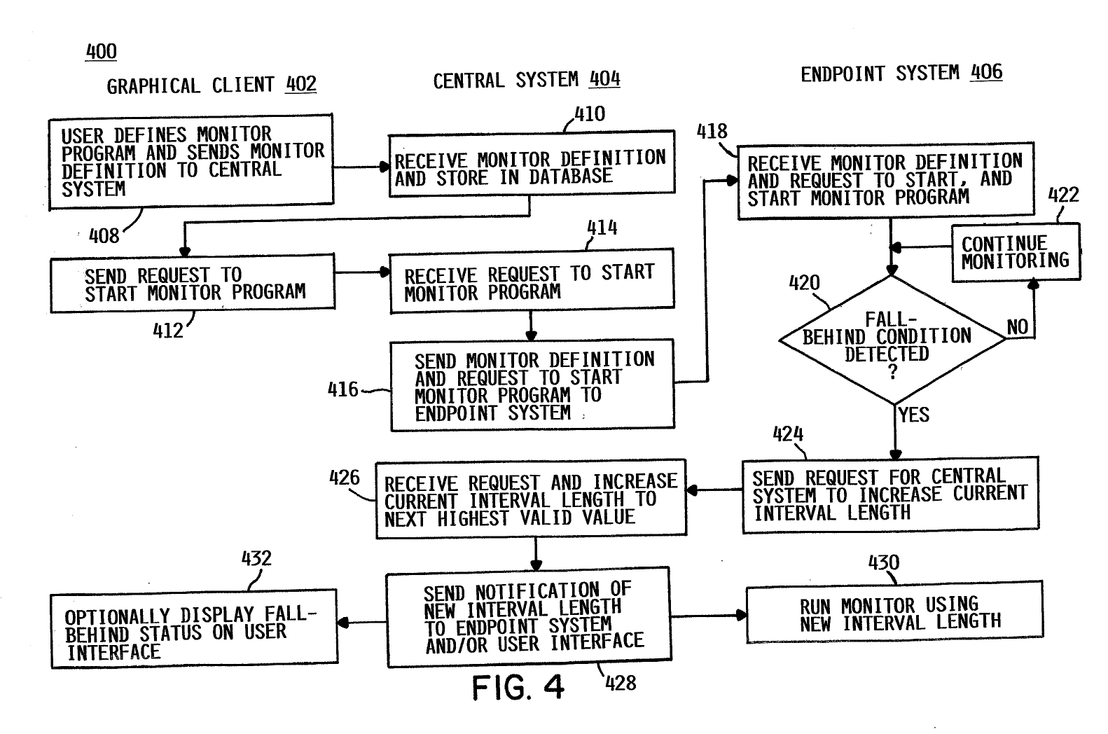

Operations of the monitor program 224 may be described with reference to FIG. 4, which is a flow diagram illustrating exemplary operations of a method 400 according to one embodiment of the present invention. As illustrated, the method 400 comprises a graphical client routine 402 (i.e., illustrative steps taken by the graphical client 230), a central system routine 404 (i.e., illustrative steps taken by the central system 210), and an endpoint system routine 406 (i.e., illustrative steps taken by an endpoint system 220).

The method 400 is initiated at step 408 when a user defines a monitor program and sends the monitor definition 216 to a central system 210. For example, the user may be a system administrator logged into the central system 210 via the graphical client 230. As previously described, the monitor definition 216 specifies the endpoint system 220 to monitor, one or more metrics to monitor and a monitor interval for each metric. The monitor definition 216 may also specify a group of endpoint systems (a “system group”). However, for ease of illustration, this description will refer to a single endpoint system. At step 410, the central system 210 receives the monitor definition 216 and stores it in the database 214.

When the user is ready to run the monitor program, at step 412, a request to start the monitor program is sent from the graphical client 230 to the central system 210. At step 414, the central system 210 receives the request to start the monitor program. At step 416, the central system 210 sends the monitor definition 216 and a request to start the monitor program to the endpoint system 220. At step 418, the endpoint system 220 receives the monitor definition 216 and the request to start from the central system 210, and an instance of the monitor program 224 (i.e., a new thread for the monitor program 224) is created on the endpoint system 220 according to the monitor definition 216. The monitor program 224 gathers monitor data 218 for one or more metrics over a monitor interval specified by the user in the monitor definition 216, and sends the monitor data 218 to the central system 210 to be stored in the database 214.

As illustrated, the main thread of execution for the monitor program 224 on the endpoint system 220 may have an associated work queue 226. When the work queue 226 is empty, there is no additional work for the thread to do, so the thread waits on the work queue 226. When the monitor interval expires, a request to collect data is placed on the work queue 226. Under normal conditions, the thread dequeues this request, processes the current interval, and returns to wait on the queue. If no more work requests are available, the main thread returns to wait on the queue again. For example, the monitor program 224 may be configured to monitor job log messages for one or more jobs running on the endpoint system 220. When a monitor interval expires, the monitor program 224 retrieves the current interval's job log messages, for example, via API calls, which may take a varying amount of processing time. If the user specifies a relatively short interval length and/or many jobs to monitor, for example, the monitor program 224 may fall behind.

At step 420, the monitor program 224 determines whether a fall-behind condition has occurred (i.e., the monitor program 224 cannot process monitor data fast enough using the current monitor interval). The monitor program 224 may be configured to detect a fall-behind condition according to any suitable technique. When the monitor program 224 falls behind, it happens because the main thread of the monitor program 224 is taking so long to process data for an interval that processing data for subsequent intervals is affected. One technique to detect a fall-behind condition is to monitor the work queue 226 for one or more requests to collect data. If one or more requests to collect data are in the work queue 226, a request to collect data for a previous interval has not been processed (and, therefore, not de-queued). For some embodiments, when a certain hard-coded threshold number of requests to collect data are detected in the work queue 226, the monitor program 224 determines a fall-behind condition has occurred.

If a fall-behind condition is not detected, the monitor program continues monitoring at step 422. If a fall behind condition is detected, then, at step 424, the endpoint system 220 sends a request to increase the current monitor interval to the central system 210. For example, the endpoint system 220 may utilize notification methods included with the network management software 222 to send the request to the central system 210. At step 426, the central system receives the request and increases the current interval length to the next highest valid value. At step 428, the central system sends notification of the new monitor interval to the endpoint system 220 and/or the graphical client 230. At step 430, the monitor program 224 continues to run using the new monitor interval. For some embodiments, the monitor program 224 uses the new monitor interval immediately, without waiting for the notification from the central system 210.

At step 432, the graphical client 230 optionally displays a notification message on the GUI 234. For some embodiments, the monitor program 224 may also be configured to perform various user-defined actions upon detecting a fall-behind condition. For example, the user may configure the monitor program to log an event if a fall-behind condition is detected or fail the monitor program if the monitor interval is increased above a maximum value.

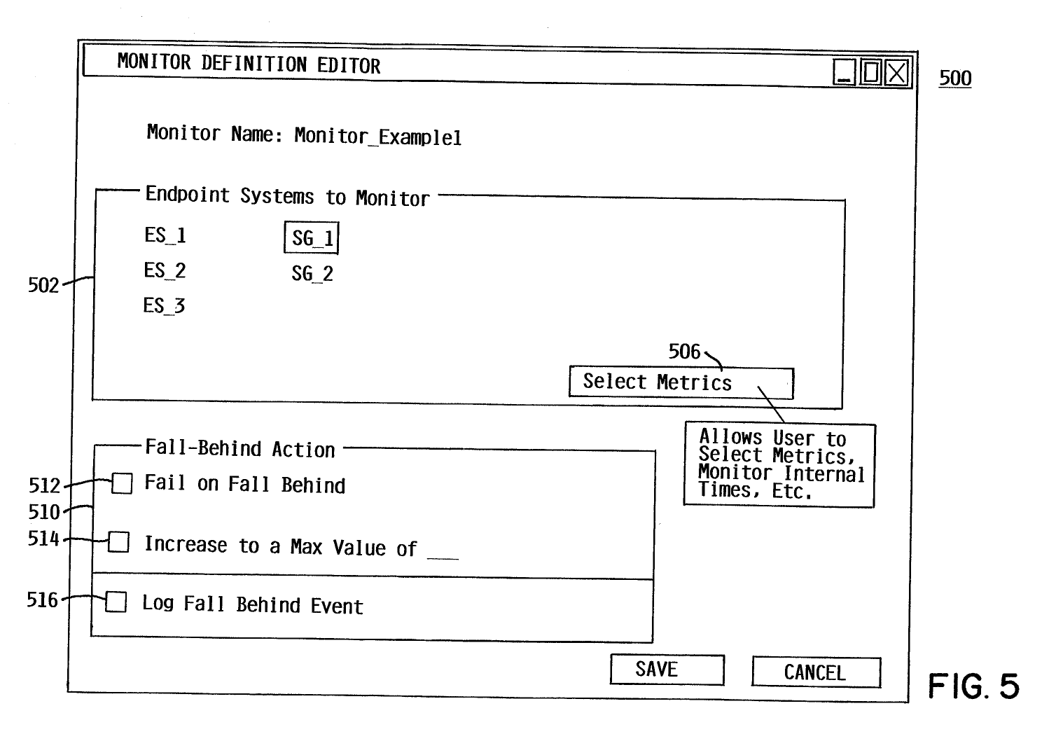

FIG. 5 illustrates an exemplary GUI screen 500 for creating a monitor definition. The screen 500 includes an “Endpoint System” window 502 for selecting endpoint systems to monitor, with a “Select Metrics” button 506 to launch a separate screen for choosing metrics to monitor for a selected endpoint system. As illustrated, a “Fall-Behind Action” window 510 allows the user to select actions to take upon detecting a fall-behind condition. For example, the user may instruct the monitor program to fail upon detecting a fall-behind condition, increase the monitor interval to a maximum value, and/or log a fall-behind event.

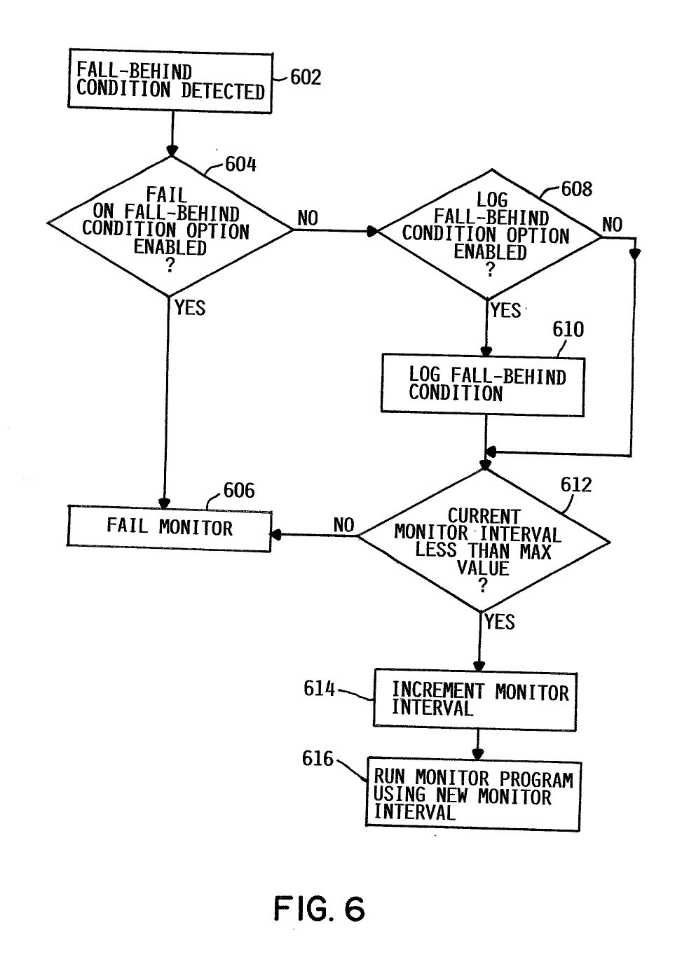

The user-selectable actions illustrated in FIG. 5 may be described with reference to the exemplary operations of a method 600 illustrated in FIG. 6. The method 600 is initiated in step 602, when a fall-behind condition is detected. At step 604, if a “Fail on Fall-Behind” option 512 is enabled, the monitor fails at step 606. At step 608, if the “Log Fall-Behind Event” option 516 is enabled, the fall-behind condition is logged at step 610. For example, the endpoint system 220 may send a notification event message to the central system 210 and the fall-behind event may be logged in database 214. At step 612, if the current monitor interval is equal to or greater than a maximum value (as specified in option 514), the monitor program fails at step 606. At step 612, if the current monitor interval is less than a user-specified maximum value, the monitor interval is increased at step 614.

It should be noted that the user-selectable actions described above are merely illustrative of various actions that may be specified by a user, and that various other actions may also be specified. For example, a user may also specify that the monitor program fail after the monitor interval is increases a maximum number of times. Further, a user may specify a program to run upon encountering a fall-behind condition. Still further, a user may specify a list of email addresses to receive a notification message in the event of a fall-behind condition.

Persons skilled in the art will recognize that the foregoing methods for dynamically adjusting a monitor interval of a monitor program are merely illustrative. More generally, any method for determining a fall-behind condition has occurred and for adjusting a monitor interval length, whether known or unknown, may be used.

Accordingly, embodiments of the present invention provide a monitor program that is more robust than current monitor programs that fail in response to a fall-behind condition. By dynamically adjusting a monitor interval in response to detecting a fall-behind condition, the monitor program of the present invention may self-correct and avoids future fall-behind conditions. In some aspects, this process may significantly ease resource management by avoiding the data loss encountered when current monitor programs fail prematurely.

While the foregoing is directed to embodiments of the present invention, other and further embodiments of the invention may be devised without departing from the basic scope thereof, and the scope thereof is determined by the claims that follow.

What is claimed is:

1. A method comprising:
monitoring, with a monitor program, one or more performance metrics of a computer system over a monitor interval;
determining whether the monitor program has fallen behind in processing data for the one or more performance metrics; and
if so, automatically increasing a length of the monitor interval.

2. The method of claim 1, wherein increasing a length of the monitor interval comprises increasing a length of the monitor interval to one of a plurality of predetermined values.

3. The method of claim 1, further comprising logging an event in response to determining the monitor application has fallen behind in processing data for the one or more performance metrics.

4. The method of claim 1, further comprising:
determining, subsequent to increasing the length of the monitor interval, whether the monitor program has fallen behind in processing data for the one or more performance metrics for a predetermined period; and
if not, decreasing the length of the monitor interval.

5. The method of claim 1, wherein determining the monitor program has fallen behind in processing data for the one or more metrics monitored over the monitor interval comprises inspecting a queue.

6. The method of claim 5, wherein the one or more performance metrics comprise job log messages and processing data for the one or more performance metrics comprises retrieving the job log messages through application programming interface (API) calls.

7. The method of claim 1, further comprising:
determining if the monitor interval has been increased beyond a predetermined maximum value; and
if so, causing the monitor program to fail.

8. The method of claim 1, wherein the monitored computer system is part of a network of computer systems.

9. The method of claim 8, wherein the network comprises the monitored computer system in communication with a central computer system.

10. The method of claim 9, wherein increasing a length of the monitor interval comprises sending a message from the monitored computer system to the central computer system.

11. The method of claim 9, wherein the monitor program is defined by a monitor definition stored in a database on the central computer system.

12. The method of claim 11, wherein a user on a client computer system in communication with the central system creates the monitor definition.

13. The method of claim 12, further comprising taking a user-specified action in response to determining the monitor program has fallen behind in processing data for the one or more performance metrics, wherein the user-specified action is part of the monitor definition.

14. The method of claim 13, wherein the user-specified action comprises at least one of failing the monitor program, increasing a length of the monitor program to a value not to exceed a user-specified maximum value, and logging an event.

15. A computer readable medium containing a program which, when executed, performs an operation for monitoring one or more performance metrics of a computer system over a monitor interval, the operation comprising:
determining whether the program has fallen behind in processing data for the one or more performance metrics over the monitor interval; and
if so, increasing a length of the monitor interval.

16. The computer readable medium of claim 15, wherein the program is part of a network management software package and wherein the computer system executes an instance of the network management software package.

17. The computer readable medium of claim 16, wherein the operation further comprises sending data for the one or more performance metrics to a central computer system executing an instance of the network management software package.

18. The computer readable medium of claim 16, wherein increasing the length of the monitor interval comprises sending a request message to a central computer system executing an instance of the network management software package.

19. The computer readable medium of claim 16, wherein the operation further comprises:
receiving a notification message from the central system acknowledging the increased monitor interval; and
monitoring the one or more performance metrics using the increased monitor interval.

20. The computer readable medium of claim 15, wherein determining whether the program has fallen behind in processing data for the one or more performance metrics monitored by the program comprises inspecting a work queue.

21. The computer readable medium of claim 15, wherein the one or more performance metrics comprise job log messages.

22. A system comprising:
a) a central computer system comprising a database;
b) a graphical client connected to the central computer system via a first network connection, the graphical client comprising a graphical user interface (GUI) configured to receive user input to define a monitor program and to send the monitor definition to the central system for storage in the database; and
c) one or more endpoint computer systems connected to the central system via a second network connection, each of the endpoint systems comprising a monitor program configured to receive the monitor definition from the central system, to monitor one or more performance metrics over a monitor interval specified in the monitor definition, and to increase a length of the monitor interval in response to determining the monitor program has fallen behind in processing data for the one or more performance metrics.

23. The system of claim 22, wherein the first network connection is a wireless connection.

24. The system of claim 23, wherein the graphical client is a cellular telephone or a personal digital assistant (PDA).

25. The system of claim 23, wherein the database, the GUI, and the monitor programs are part of a network management software package.

26. The system of claim 22, wherein the monitor program is configured to send a request message for increasing the monitor interval to the central system in response to determining the monitor program has fallen behind in processing data for the one or more performance metrics.

27. The system of claim 26, wherein the central computer system is configured to increase the monitor interval length and update the monitor definition stored in the database in response to receiving the request message from the monitor program.

28. The system of claim 27, wherein the GUI is configured to display a plurality of predetermined monitor interval lengths and wherein the central system is configured to increase the length of the monitor interval to one of the plurality of predetermined monitor interval lengths.

29. The system of claim 22, wherein the GUI is configured to display a list of actions to take by the monitor program upon determining the monitor program has fallen behind in processing data for the one or more performance metrics.

30. The system of claim 29, wherein the list of actions comprises failing the monitor program and logging an event.
